(19) United States
(12) Patent Application Publication
(10) Pub. No.: US 2006/0118131 A1
(43) Pub. Date: Jun. 8, 2006

(54) Dental floss coated with soywax

(75) Inventors: Alimohammad Evazynajad, Langhorne, PA (US); W.E. LeGrande, Reading, PA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Gudebrod, Inc.

(21) Appl. No.: 11/204,453

(22) Filed: Aug. 16, 2005

Related U.S. Application Data
(60) Provisional application No. 60/634,129, filed on Dec. 8, 2004.

(51) Int. Cl. A61C 15/00

(52) U.S. Cl. 132/321

(57) ABSTRACT

PTFE dental floss is coated with Soywax. The Soywax coated floss improves gripability, handling and comfort, and fibrillation resistance without negating the natural lubricious properties of the PTFE material.

### CROSS-REFERENCE TO RELATED APPLICATION

This application claims the benefit of U.S. Provisional Application 60/634,129, filed Dec. 8, 2004, incorporated by reference herein in its entirety.

### FIELD OF THE INVENTION

This invention relates generally to dental floss and more specifically to coated dental floss.

### BACKGROUND OF THE INVENTION

Dental flosses have long been used to clean the spaces between teeth and along the gum line. However, pulling the floss between teeth toward the gums can cause gum injury, specifically cutting of the gums by the floss. A common method to reduce the risk of gum injury is to coat the floss with a lubricant, such as wax. Coated floss reduces the coefficient of friction of the floss and, as a result, the floss slides more easily between the teeth and is less likely to cut the gums.

Conventional waxing of dental floss includes coating the dental floss with a wax that has a melting point between 135°-200° F. Suitable waxes for such coatings include beeswax, paraffin, Candelilla, jojoba, microcrystalline, and Carbowax. In addition, the wax coating can carry flavors, such as mint, cinnamon, or the like.

Another method of reducing the coefficient of friction of dental floss is to fabricate the floss from polytetrafluoroethylene (PTFE) or expanded PTFE (ePTFE), which has increased strength and a low coefficient of friction. PTFE has excellent high and low temperature capability that allows it to maintain its beneficial properties at temperature ranges between −100° F. and +500° F., good electrical and thermal insulation characteristics, good chemical resistance, a low coefficient of friction, and is inherently lubricious (i.e. it exhibits a “slipperiness”). PTFE is very dense and cannot easily be melt processed. Typically, PTFE fiber is used in different applications such as dental floss, and is formed through a variety of textile forming processes including, for instance, knitting, and braiding.

However, the low friction coefficient of PTFE can make handling the floss by a user difficult because the floss tends to slip between the user's fingers. To overcome this problem, PTFE floss has been coated with wax to increase the friction coefficient for better handling. However, wax coatings can raise the friction coefficient of the PTFE substantially, thereby, largely negating the benefits of the PTFE when sliding between the teeth.

What is needed is a coating for PTFE dental floss that will increase the friction coefficient of the floss to make handling easier and that will increase the contact surfaces with the tooth, while maintaining the coefficient of friction with teeth low enough to slide easily between the teeth.

### SUMMARY OF THE INVENTION

Briefly described, the present invention, in a preferred embodiment, is a PTFE or ePTFE dental floss that is coated with Soywax or a Soywax blend. The Soywax improves gripability, handling and comfort, and fibrillation resistance of the dental floss, without substantially negating the beneficial properties of the PTFE material. Further, PTFE floss coated with Soywax has been shown to increase the surface area of the tooth that is contacted and cleaned by the floss.

In addition to the above benefits, Soywax is made from 100% renewable sources such as soybeans and other plant oils. Soywax itself offers a number of other important advantages, including providing a superior coating that increases the coefficient of friction of the floss for better handling, is cost efficient, and biodegradable.

In contrast to prior art coatings, the present invention contemplates Soywax as a coating for PTFE dental floss. Another benefit of Soywax in contrast to prior art waxes is that natural Soywax provides enhanced gripability to the PTFE or ePTFE dental floss. Further, natural Soywax is cost effective and offers several distinct advantages over other waxes, such as, for example, it is non-toxic, completely natural, made from renewable resources, and biodegradable.

PTFE fiber itself generally has a white appearance (if not pigmented with color). After treatment according to the invention, the PTFE or ePTFE fiber generally is a coated tape, which can be used for dental floss.

Thus, an improved Soywax coated PTFE dental floss is now provided that successfully addresses the needs left unfulfilled by the prior art. The dental floss of this invention exhibits superior gripability for enhanced handling while at the same time retaining the inherent lubricious nature of PTFE so that the floss slides easily between the teeth. As a result, gum injury is reduced substantially, cleaning efficiency is enhanced, and undesirable fibrillation is reduced significantly.

These and other features and advantages of the present invention will become more apparent upon review of the detailed description set forth below.

### DETAILED DESCRIPTION

Certain exemplary embodiments of the present invention are described below. These embodiments are presented only for purposes of illustrating the present invention and should not be interpreted as limiting the scope of the invention, which, of course, is limited only by the claims. Other embodiments of the invention, and certain modifications and improvements of the described embodiments, will occur to those skilled in the art, and all such alternate embodiments, modifications, and improvements are within the scope of the present invention.

The following terms used herein should be accorded the corresponding definitions: The term “dental floss” includes products known as dental floss and products known as dental tape. “Engineering strain” is defined as the change in length of a test specimen divided by the original length of the specimen. Engineering strain is normally expressed as a percentage. “Break strength” defines the greatest load that is supported by a fiber. Break strength is normally expressed in pounds or kilograms. “Denier” details a unit of linear density. Denier is generally expressed in grams per 9000 meters. Throughout the application, the terms PTFE and ePTFE are used interchangeably. Generally, ePTFE has enhanced properties, such as peak engineering, toughness, and break strength. One of ordinary skill will appreciate that either can be used in the processes and products formed herein and specific references to one type of floss fiber should not be limiting, but should encompass both PTFE and ePTFE.

The present invention is directed to a PTFE or ePTFE dental floss that is coated with Soywax to improve the gripability, handling and comfort, and fibrillation resistance of the floss. Soywax can be applied to the PTFE or ePTFE dental floss by any method.

The Soywax applied to the PTFE or ePTFE typically is held at or near a certain temperature, and generally contains an additive in particle form. The additives can include all Food and Drug Administration (FDA) approved foods or flavors, including icy mint, mint, cinnamon, cranberry, lemon lime, bubble gum, cherry, and the like. Preferred application temperature ranges for the Soywax are between approximately 150°-180° F.

The thread length for the dental floss is determined generally by the amount of thread that can be woven on a plastic bobbin. The bobbin package should be firmly attached so that the core does not become easily detached therefrom. However, other types of floss can be used, such as coreless floss, where no core is required. Such coreless floss also should be firmly attached to the bobbin package without concern for separating at the core.

While the invention should not be limited by theories of Soywax performance, it is believed that the softer qualities of Soywax in comparison to other types of wax (e.g. beeswax, etc.) allows the coated dental floss to slide more easily between teeth. As an example, beeswax has a higher melt temperature (approximately 200° F.) than Soywax (approximately 150 to 160° F.), which indicates Soywax is softer than Beeswax and may begin to soften at lower temperatures akin to human body temperature.

Technical Data

In the alternative to the fibers described above, different Denier (D) PTFE or ePTFE can be used. These different sizes generally comprise a range of approximately 500 D-1600 D. The floss formed through any of the forming processes detailed above or as an end product can be formed as either a round or a flat dental floss.

While the invention has been disclosed in its preferred forms, it will be apparent to those skilled in the art that many modifications, additions, and deletions can be made herein without departing from the spirit and scope of the invention and its equivalents as set forth in the following claims.

We claim:

1. A dental floss comprising an ePTFE strand coated with Soywax.

2. The dental floss of claim 1 wherein the strand has a density of about 500-1600 Denier.

3. The dental floss of claim 1 wherein the Soywax increases the coefficient of friction of the strand.

4. The dental floss of claim 3 wherein the Soywax has melting point of 130-150° F.

5. A method of forming coated dental floss comprising:
forming a strand of expanded PTFE;
coating the strand with Soywax.

6. The method of claim 5 wherein the dental floss has a flavoring applied thereto.

7. The method of claim 6 wherein the flavoring is mint.

8. A dental floss coated with Soywax formed without a core.

9. A method of forming coated dental floss comprising:
forming a strand of nonexpanded PTFE;
coating the strand with Soywax.

10. The method of claim 9 further comprising:
applying a flavoring to the strand.

11. The method of claim 10 wherein the flavoring is mint.

12. The method of claim 9 further comprising:
winding the strand on a bobbin.

13. The method of claim 9 where the floss is coreless.

14. The dental floss of claim 9 wherein the Soywax increases the coefficient of friction of the strand.
